(19) United States
(12) Patent Application Publication
(10) Pub. No.: US 2009/0165822 A1
(43) Pub. Date: Jul. 2, 2009

(54) EXTRACTION CLEANING APPARATUS

(76) Inventors: RONALD P. KINTZ, North Canton, OH (US); Greg A. Bilek, Doylestown, OH (US); Andrew C. Budd, Clinton, OH (US); David A. Cotsmire, North Canton, OH (US); Evan A. Gordon, Canton, OH (US); Touby Khamphilipanyo, Garfield Heights, OH (US); Jeff S. Louis, Akron, OH (US)

Correspondence Address: TTI Floorcare North America, Inc., 7005 Cochran Road, Glenwillow, OH, 44139, US

(21) Appl. No.: 12/236,811

(22) Filed: Sep. 24, 2008

Related U.S. Application Data
(60) Provisional application No. 60/994,838, filed on Sep. 24, 2007.

(51) Int. Cl. A47L 7/00; A47L 13/10; B05B 1/00

(52) U.S. Cl. 134/18; 15/320; 239/589

(57) ABSTRACT

An extraction cleaning apparatus includes separate cleaning tanks for water and detergent and optionally also for rinse agent. The apparatus is able to sense its direction of travel and/or rate of travel and to control the cleaning liquid composition and/or rate of its delivery onto the floor in accordance therewith. For example, the apparatus is able to dispense detergent at a higher rate when the forward rate of travel increases and to dispense only water and/or rinse agent in the reverse direction.

This application claims the benefit to U.S. provisional patent application entitled “Extractor Vacuum” having Ser. No. 60/994838 filed Sep. 24, 2007, the entire disclosure of which is hereby incorporated by reference.

The present exemplary embodiment relates to a cleaning apparatus. More specifically, it relates to fluid dispensing and recovery systems for extractor-type cleaning devices.

It is known to have an extraction cleaning device for cleaning a surface, such as a carpet or hard floor, in which a cleaning solution that includes a detergent is dispensed to the surface from a liquid supply tank and substantially simultaneously extracted along with the dirt on the surface into a recovery tank in a continuous operation. An advantage of such devices is that a consumer is able to clean the floor surface whenever desired, and in particular, directly after a potentially stain causing spill. One drawback of such devices is that the liquid distribution system can be inefficient, resulting in too much or too little detergent application. Further, such systems are generally not capable of completely removing all of the detergent, which can make the dirt and other stain causing elements more likely to stick to the carpet after cleaning.

In view of these and other problems, it is evident that the need exists for an extraction cleaning apparatus that efficiently and conveniently applies cleaning liquids to a carpet.

### BRIEF DESCRIPTION

In accordance with one aspect of the present exemplary embodiment, an extraction cleaning apparatus includes a first cleaning liquid supply tank configured to hold a first cleaning liquid and a second cleaning liquid supply tank configured to hold a second cleaning liquid. A base assembly dispenses the first and second cleaning liquids on to a floor surface and receives recovered cleaning liquid from the floor surface. A liquid distribution system in communication with the first cleaning liquid supply tank and the second cleaning liquid supply tank selectively conveys the first and second cleaning liquids to the base assembly. A sensor system senses at least one of a direction of travel and a rate of movement of the cleaning apparatus. The apparatus has at least a first cleaning mode in which a rate at which the first cleaning liquid is dispensed from the base assembly is based on at least one of the sensed direction of travel of the cleaning apparatus and a rate of movement of the cleaning apparatus.

In another aspect, a cleaning apparatus includes a first cleaning liquid supply tank configured to hold a supply of a first cleaning liquid and a second cleaning liquid supply tank configured to hold a supply of a second cleaning liquid. A liquid distribution system is in communication with the first and second cleaning liquid supply tanks, and selectively conveys the first and second cleaning liquids to a distributor. A sensor system senses at a direction of travel of the cleaning apparatus. A control system in communication with the sensor system controls the liquid delivery system such that the first cleaning liquid is applied to the floor surface from the distributor when the sensed direction of travel is a first direction and the second cleaning liquid is applied to the floor surface from the distributor when the sensed direction of travel is the second direction, whereby a composition of the cleaning liquid applied to the floor surface from the distributor is different in the first and second directions.

In another aspect, a liquid delivery system for a floor cleaning apparatus includes a first tank for holding a supply of water, a second tank for holding a supply of detergent, and a third tank for holding a supply of rinse agent. An arrangement of fluid lines and valves selectively connect the first second and third tanks with a liquid distributor. A control system is in operative communication with the valves whereby a composition of cleaning liquid comprising the at least one of the water, detergent, and rinse agent delivered to the distributor is varied, based on a detected direction of travel of the floor cleaning apparatus.

An advantage of some implementations is that the cleaning liquid delivered to a floor surface is automatically variable in at least one of composition and delivery rate depending on at least one of speed and direction of a floor cleaning apparatus.

An advantage of some implementations is that detergent is automatically rinsed from the floor surface.

An advantage of some implementations is that wastage of detergent is reduced.

An advantage of some implementations is that detergent is dispensed more uniformly in the cleaning direction.

### BRIEF DESCRIPTION OF THE DRAWINGS

FIG. 1 is a front perspective view of an extraction cleaning apparatus in accordance with one aspect of the exemplary embodiment;

FIG. 2 is a rear perspective view of the extraction cleaning apparatus of FIG. 1;

FIG. 3 is a front view of the extraction cleaning apparatus of FIG. 1;

FIG. 4 is a side view of the extraction cleaning apparatus of FIG. 1;

FIG. 5 is an exploded view of the base assembly of the extraction cleaning apparatus of FIG. 1;

FIG. 6 is an enlarged exploded view of the recovery tank assembly of the base assembly of FIG. 5;

FIG. 7 is an enlarged perspective view of the base assembly of the extraction cleaning apparatus of FIG. 1, showing the centrally positioned light and spot spray nozzle;

FIG. 8 is an enlarged exploded perspective view of the spot sprayer and light of the base assembly of FIG. 7;

FIG. 9 is an exploded perspective view of a lower portion of the handle assembly of the cleaning apparatus of FIG. 1;

FIG. 10 is an exploded perspective view of an upper portion of the handle assembly of the cleaning apparatus of FIG. 1;

FIG. 11 is an exploded perspective view of the clean water tank of the cleaning apparatus;

FIG. 12 is an exploded view of the handle assembly and liquid tanks of the of the extraction cleaning apparatus FIG. 1;

FIG. 13 is an exploded perspective view of the chemical tank assembly of the cleaning apparatus;

FIG. 14 is a perspective view of the chemical tank assembly of FIG. 13;

FIG. 15 is a perspective view of the of the extraction cleaning apparatus with the front housings and liquid tanks removed;

FIG. 16 is a schematic view of a liquid distribution system of the cleaning apparatus illustrating a fluid flow path during forward movement of the of the extraction cleaning apparatus while in an auto-wash mode in accordance with one aspect of the exemplary embodiment;

FIG. 17 is a schematic view of a fluid flow path during rearward movement of the of the extraction cleaning apparatus while in the auto-wash mode;

FIG. 18 is a schematic view of a fluid flow path during a water only mode in accordance with one aspect of the exemplary embodiment;

FIG. 19 is a schematic view of a fluid flow path during spot spray actuation in accordance with one aspect of the exemplary embodiment;

FIG. 20 is a schematic view of a flow path during above the floor tool use in accordance with one aspect of the exemplary embodiment;

FIG. 21 is an exploded perspective view of the mixing manifold of the extraction cleaning apparatus in accordance with one aspect of the exemplary embodiment;

FIG. 22 is an exploded perspective view of one of the fluid ports for rinse liquid, spot spray, and detergent in accordance with one aspect of the exemplary embodiment;

FIG. 23 is an exploded perspective view of one of the fluid ports for rinse liquid, spot spray, and detergent in accordance with another aspect of the exemplary embodiment;

FIG. 24 is a schematic view of a liquid distribution system of the cleaning apparatus in accordance with one aspect of the exemplary embodiment, illustrating a fluid flow path during forward movement of the of the extraction cleaning apparatus while in an auto-wash mode;

FIG. 25 is a side sectional view of the base assembly showing a sensor system which detects relative forward or backward motion of the cleaning apparatus and its rate of movement in accordance with one aspect of the exemplary embodiment,

FIG. 26 is a side elevational view of the rear wheel of the extraction cleaning apparatus;

FIG. 27 is a perspective view of a flow meter for an above floor tool of the extraction cleaning apparatus of FIG. 1; and

FIG. 28 is an exploded perspective view of the flow meter of FIG. 27.

### DETAILED DESCRIPTION

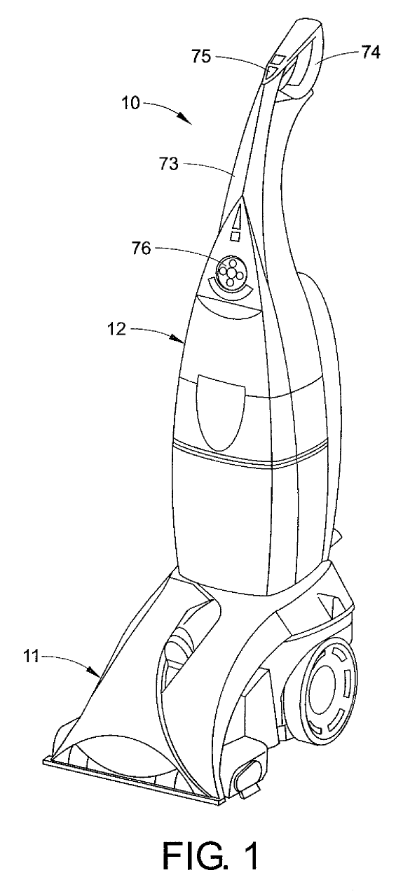

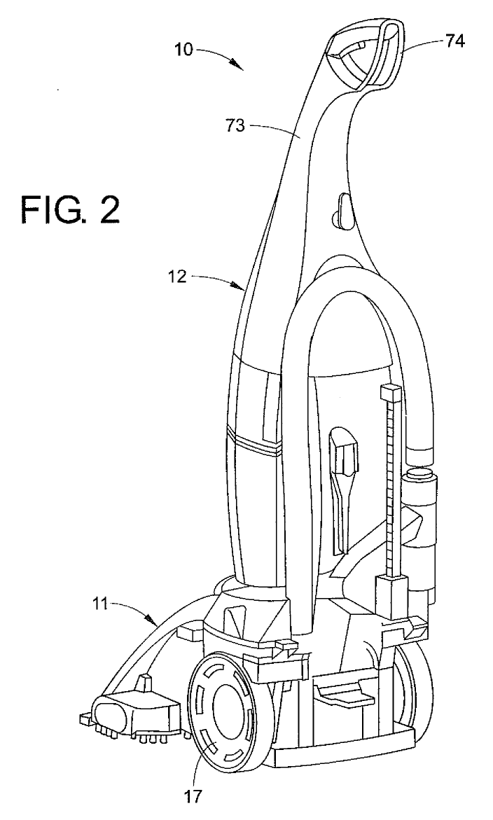

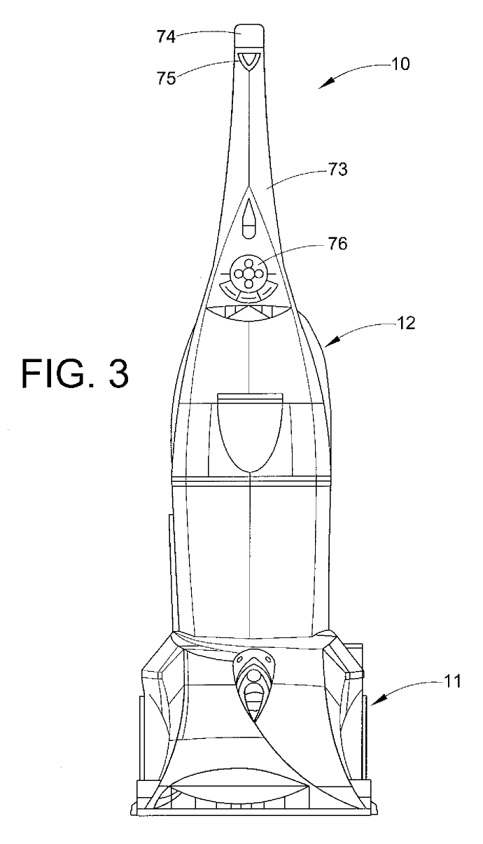

Referring now to FIGS. 1-4, an upright extraction cleaning apparatus in accordance with one aspect of the exemplary embodiment is shown and generally indicated by the numeral 10. Extraction cleaning apparatus 10 generally includes a base assembly 11 for engaging a floor surface, such as a carpet or hard floor, and a handle assembly 12. Handle assembly 12 is pivotally attached to base assembly 11 and may be articulated between a generally upright position (shown in FIGS. 1-4) and an inclined or angled orientation.

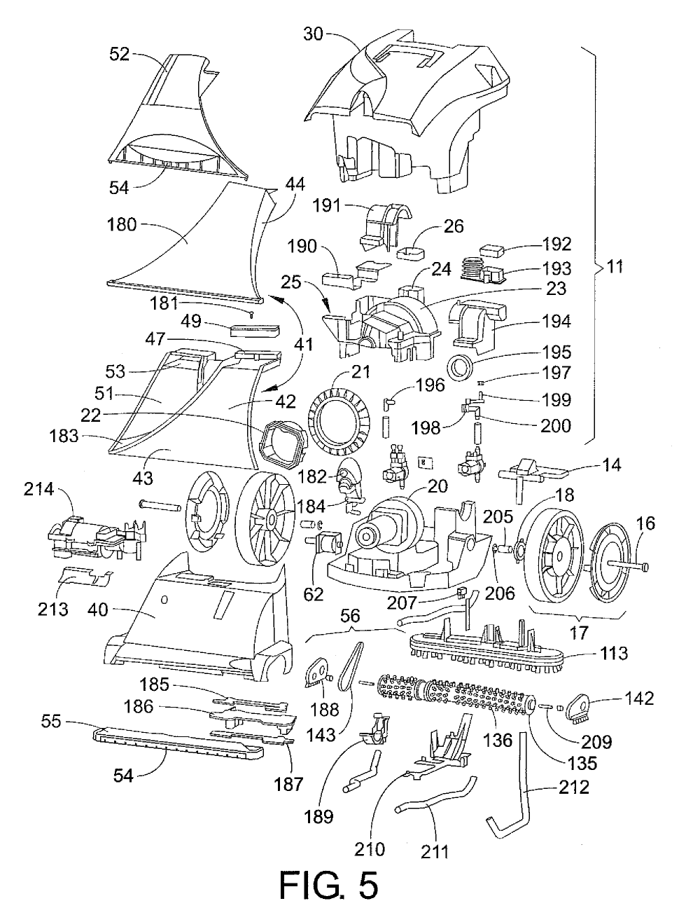

Referring now to FIG. 5, base assembly 11 includes a main body 13 that supports and carries the various components mounted in the base assembly. A handle release lever 14 is carried by main body 13 and may be depressed by a user to release handle assembly 12 from the upright position. Main body 13 also includes a pair of opposed hubs 15 that are each adapted to receive a pin 16 therein. Each pin carries a wheel 17 that is rotatably received thereon. One or more sensor systems 18 may be positioned proximate to wheels 17 and may be adapted to measure wheel speed and/or direction for use in system controls as will hereinafter be described in greater detail.

A source of suction, such as a vacuum motor assembly 20 is carried by main body 13 and provides the suction for removing dirt and water from the surface being cleaned. One or more seals 21 may be provided to minimize leakage of air from the desired air path. Further, one or more motor mounts 22 may be provided that are positioned between assembly 20 and the main body 13 to minimize vibration and enable proper attachment. A motor housing 23 is secured to main body 13 and, together with main body 13, captures motor assembly 20 therebetween. A gear box assembly 214 along with its cover 213 can be associated with the motor 20. Motor housing 23 includes an inlet port 24, which receives working air, and an outlet port 25, that exhausts working air. One or more seals 26 may be provided at inlet or outlet ports to prevent the escape of working air. Additionally, one or more additional outlet ports may be provided as alternate routes for working air, for example, an outlet port may direct working air downwardly to a carpet surface directly beneath main body 13. Also shown in FIG. 5 for the input cover and nozzle is nozzle plate 180. At the top of the nozzle assembly 41 is a seal 49 with fastener 181. At the other end of the nozzle assembly 41 at the nozzle base plate 183 area is the channel 43. The front spray and head light assembly 184 has a fastener 182 to the unit. Also the distributor 186 has a distributor upper and lower cover plate 185 and 187, respectively. The end cap with reciprocating edge brush 142 and its counterpart end cap at the other end of the agitator brush 35 both have sleeve bearing like 188 shown for the counterpart of 142. Also the agitator belt 143 has a guard 189. Around the motor housing 23, there is motor air duct cover 190 and trunnion covers 191 and 194. Also rubber hose adapter gasket 192 can be associated with the tool hose adapter 193. Also for the motor fan there is a rubber seal gasket 195. An arrangement of tubing and clamps assist in fluid conveyance and these are shown as 196, 197 a gasket, 198, 199, 200, 201 and 211. These are involved in the association of the solenoid valves 202 and 203 for fluid conveyance. For control of these valves, an electronic control printed circuit board (pcb) for example a thermistor board can be used and connected to the control system with the sensor system 18. For wheel 17 there is shown sleeve bearing 205 and rear wheel pin ring 206. With wheel sensor 208 there is associated nozzle power off micro switch 207. With the agitator brush 135 there is also shown the shaft 209 and another guard 210. Wiring for the electrical and electronic features can be through the wire harness sleeve shown at 212.

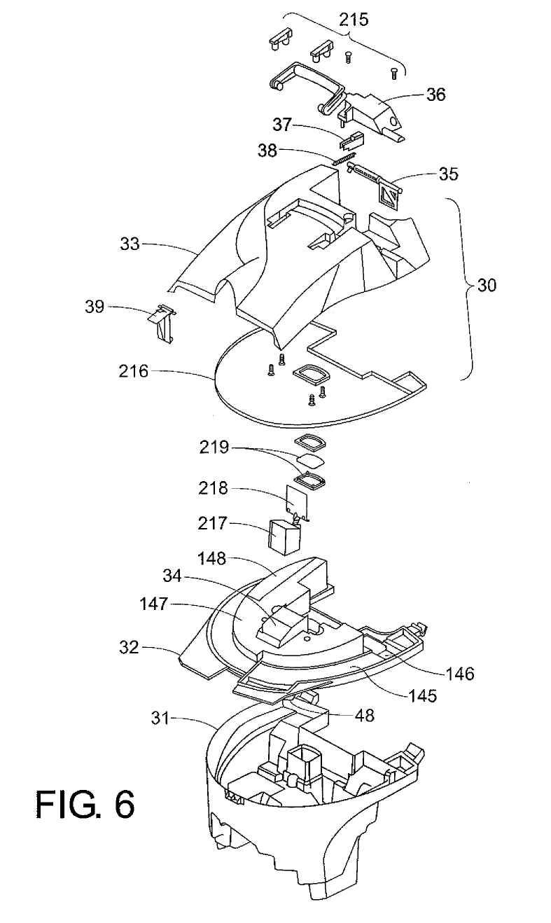

With reference also to FIG. 6, a recovery tank assembly 30 is positioned above motor assembly 20 and is adapted to receive and collect dirty water and debris from the surface being cleaned. Recovery tank assembly 30 includes a liquid carrying tank 31, a lid 32 and an upper cover 33. A float valve 34 is carried by lid 32 to prevent water entry into motor assembly 20 when tank 31 is full. Further, a pivoting flap valve 35 may be carried by cover 33 to enable conversion to above the floor cleaning. Flap valve 35 is enclosed by a valve cover 36 and is actuated by a stepped pin 37 that is biased by a spring 38. A cover latch 39 is provided to selectively secure cover 33 to tank 31. Also shown in FIG. 6 the recovery tank 30 has handle assembly 215. Also under the cover 33 there is a foam rubber piece 216 between the cover 33 and lid 32. The float valve 34 in the lid 32 assembly has the float 217 and float door 218. Associated with the float valve 34 are screen and screen holder 219.

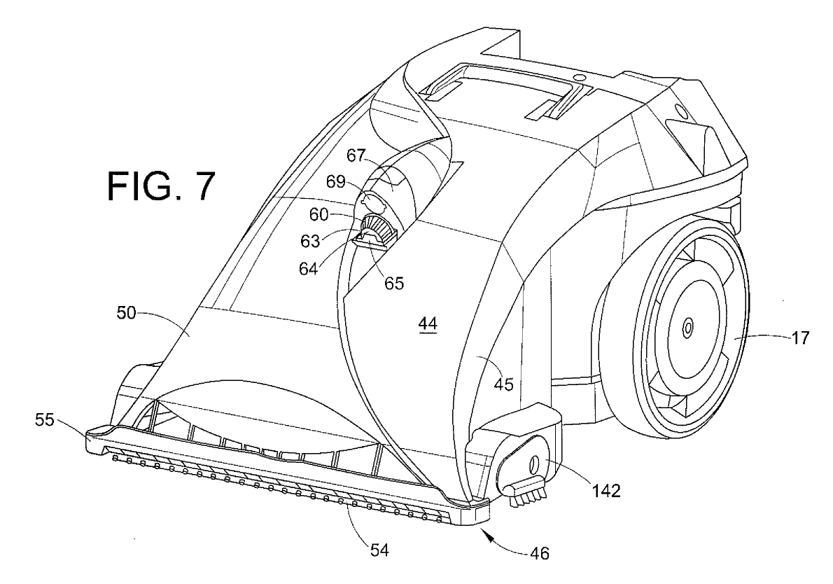

With reference once more to FIG. 5, a front shell 40 is secured to main body 13 and extends forwardly from recovery tank assembly 30. Front shell 40 supports a nozzle assembly 41 through which working air is drawn and exhausted. Nozzle assembly 41 includes a base 42 that is positioned adjacent to front shell 40. Base 42 includes an input channel 43 that, along with an input cover 44, forms an input nozzle 45 (FIG. 7). Working air and recovered liquid is drawn through an orifice 46 of input nozzle 45, proximate to the floor, and exits input channel 43 at a port 47. Port 47 is in fluid communication with a port 48 (FIG. 6) on lid 32. One or more seals 49 may be positioned between ports 47 and 48 to prevent escape of working air. An output nozzle 50 (FIG. 7) is positioned above input nozzle 45 and is formed by an output channel 51 on base 42 and by an output cover 52. Working air is expelled from motor assembly 20 via outlet port 25, which in fluidly connected to a port 53 on output nozzle 50. In this manner, working air is exhausted through orifices 54 of output nozzle 50 defined in a plate 55 at a location proximate to the surface to be cleaned.

With continued reference to FIG. 5, an agitator assembly 56 is carried inside shell 40 and is adapted to agitate and scrub the surface being cleaned. Details of agitator assembly 56 are described in co-pending application Ser. No. 61/042098, filed Apr. 3, 2008 entitled Floor Cleaning Device with Multiple Agitators, which is hereby incorporated by reference in its entirety.

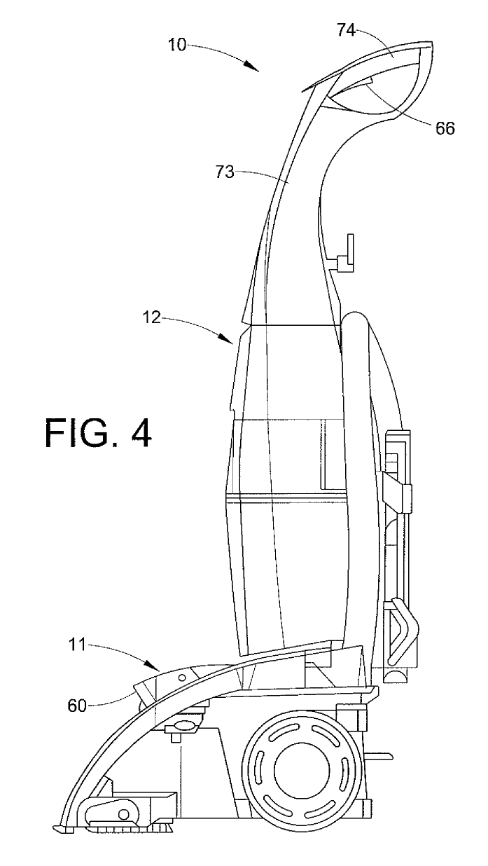

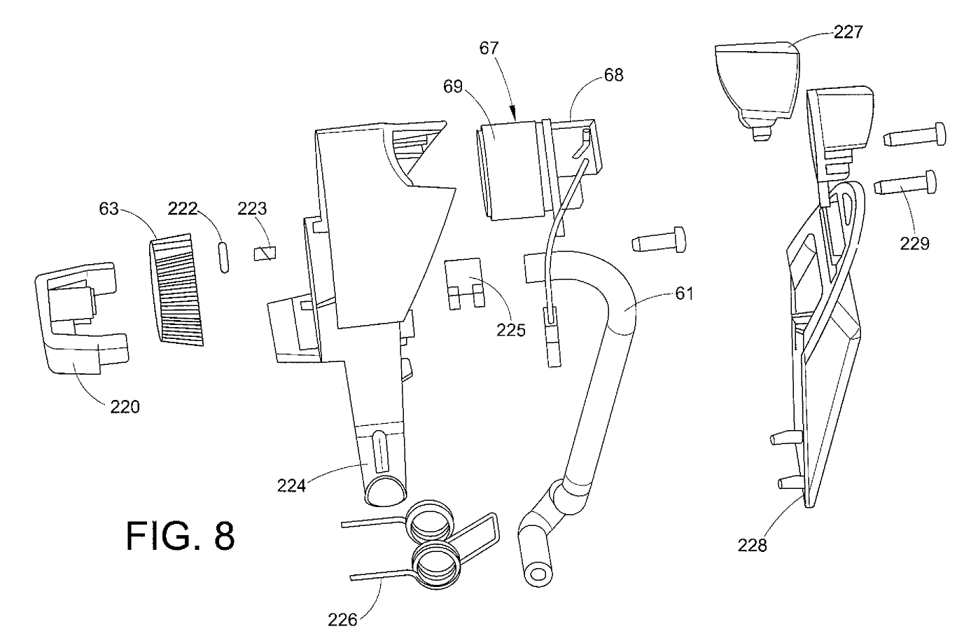

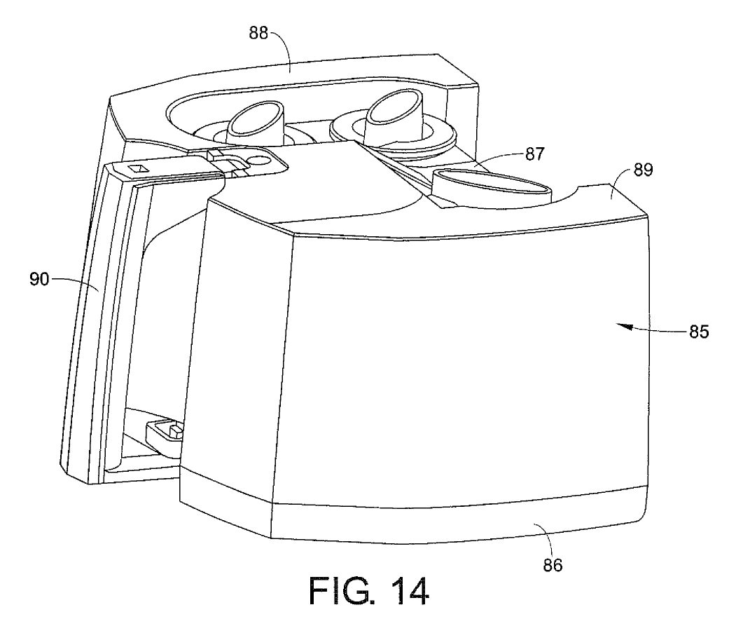

As shown in FIG. 7, a spot sprayer assembly 60 is carried by upper cover 33 and is adapted to provide directed cleaning solution, such as a concentrated liquid detergent, at the command of a user. As shown further in FIG. 8, spot sprayer assembly 60 includes an input tube 61 that is in communication with a cleaning liquid source (described below with reference to FIGS. 14-18). A pump 62 may be provided in the base assembly 11 to provide the liquid detergent at any desired flow rate (FIG. 5). The exemplary pump 62 is an AC pump, such as a solenoid pump. The liquid detergent exits tube 61 through one of a plurality of orifices provided on a rotatable cap 63 (FIG. 7). A first orifice 64 may be generally circular to produce a more concentrated stream. A second orifice 65 may be generally rectangular to produce a more dispersed, fan shaped stream. It should be appreciated that any number of orifice shapes may be employed to produce any desired spray pattern. A user may change the spray pattern by merely rotating cap 63 to align the desired orifice with the spray tube 61. The spot sprayer may 60 be actuated by the user who may press a trigger 66 (FIG. 4) or other actuating device to cause pump 62 to energize and provide detergent through tube 61.

Positioned above spot spray assembly 60 is a lamp assembly 67 including a light source, such as an LED 68 and a lens 69. As can be seen in FIG. 7, lamp assembly 67 is positioned centrally on base assembly 11 in alignment with spot spray assembly 60. In this manner, liquids that are sprayed from spot spray assembly 60 are directly illuminated while in the air. This provides a pleasing visual effect while also displaying to the user the exact distribution pattern of the spray. LED 68 also provides improved continuous lighting of the cleaning path as compared to non-LED configurations. Thus, the user can more easily see dirty areas upon which to concentrate cleaning. Also as shown if FIG. 8 a cover piece 220 is associated with rotating cap 63. For fluid conveyance within the spot sprayer behind the cap 63 there is an O-ring 222 and spot spray insert 223. The spot spray assembly 60 with the lamp assembly has a front housing half 224 and a rear housing half 228. The lamp assembly 67 has a lens 69 shown in an exploded section as 227. A water tube holder or clamp 226 assists in providing the support for fluid conveyance in tubing for the spot sprayer. The housing halves are held together by fasteners 229.

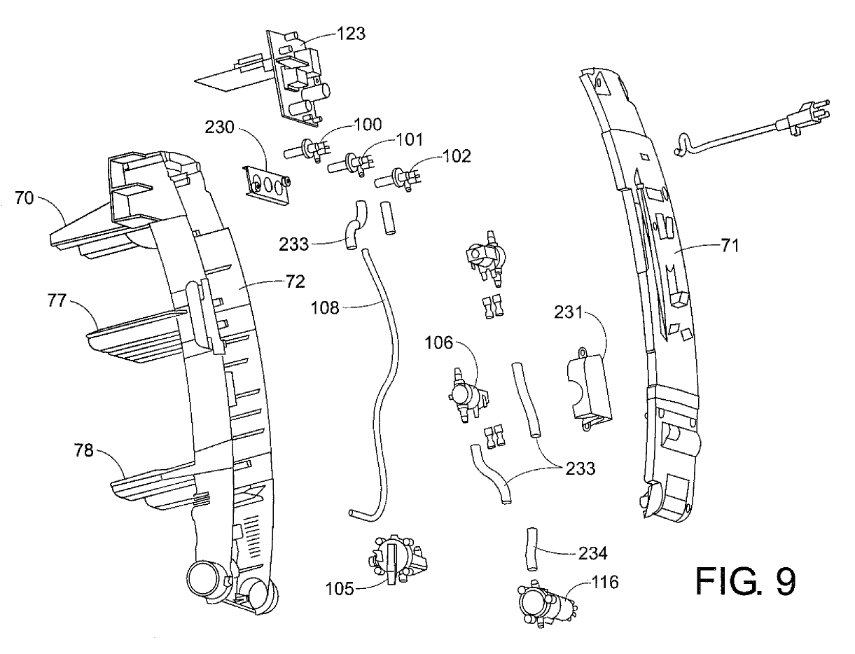

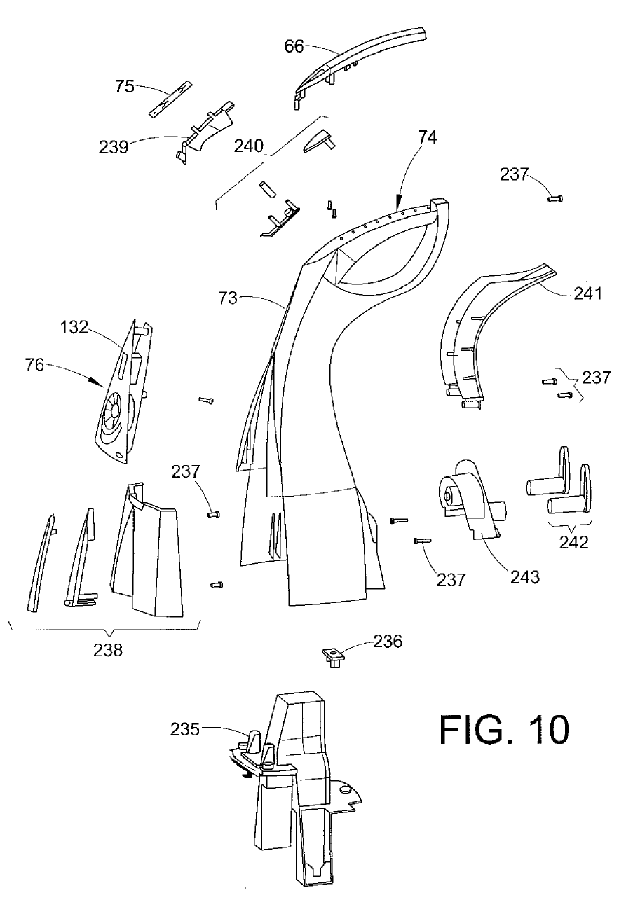

Referring now to FIGS. 9 and 10, handle assembly 12 carries the controls, as well as the various cleaning liquids which may be employed for cleaning. Handle assembly 12 includes a front housing portion 70 that is secured to a rear housing portion 71 to form a chamber 72 wherein various pumps and fluid transfer mechanisms reside. A top housing 73 is secured to the top of front and rear housing portions 70 and 71 and mounts a handle grip 74 along with various vacuum control elements such as a power switch 75, a mode control dial 76, and the trigger 66 for operating the spot sprayer 60. The front housing portion 70 includes mounting supports in the form of shelves 77, 78 for receiving cleaning liquid tanks thereon. Also as shown in FIG. 9 is the manifold support 230 for the various ports of 100, 101 and 102. Also the solenoid valve 106 has a cover 231. For the conduit lines like 108 there are tubing sections 233 along with a tube for the water tank manifold to pump 116 fluid connection. For providing the electric power such as AC to the extractor vacuum unit a power supply cord 232 leads from the unit for plugging into such a supply. Also as shown in FIG. 10, below the mode control dial 76 in top housing 73 there can be a tool door assembly 238 connected to the top housing by fasteners 237 for storing various attachment type tools in the top housing section. Within the top housing 73 can be located the upper handle insert 235 having a receptacle header 236. Along with the power switch 75 in the handle grip 74 is the Trigger 66 which has a main trigger portion 239 and which can also have an associated surge button and spring portion 240. Also the upper handle of the top housing has a cover 241 held in place by fasteners 237. Also the top housing 73 around the cover 241 can have power cord hook 242 and a plastic hose holder 243 for wrapping a hose for attachment tools (not shown in the FIGURE).

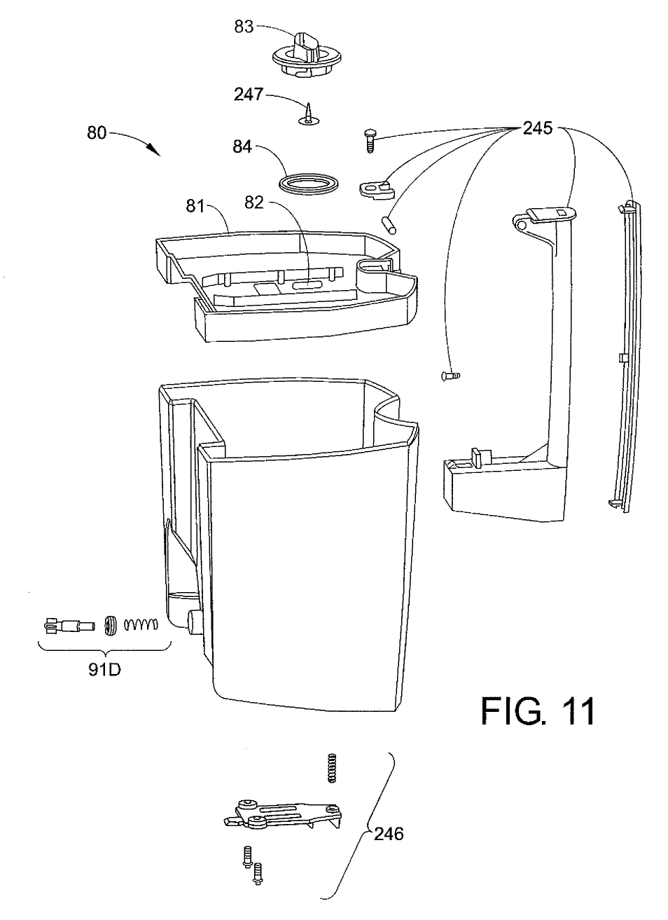

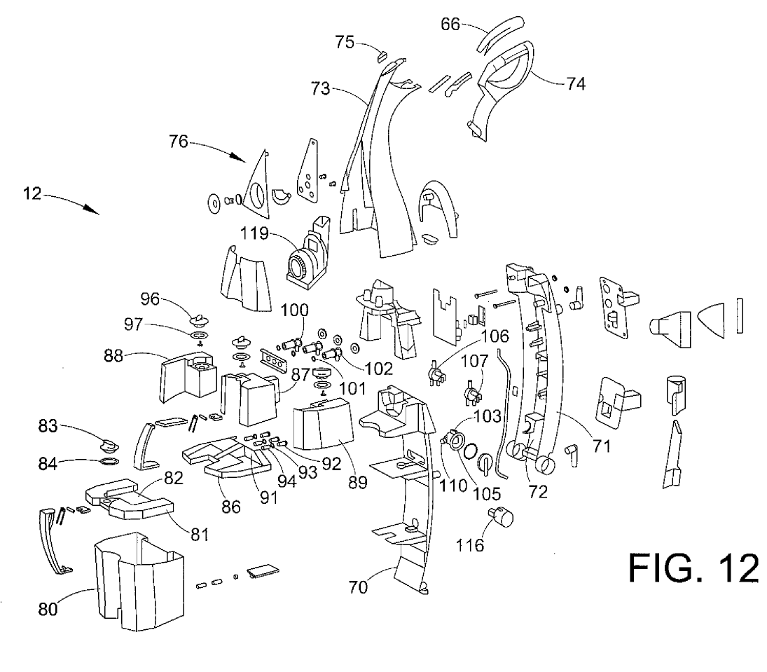

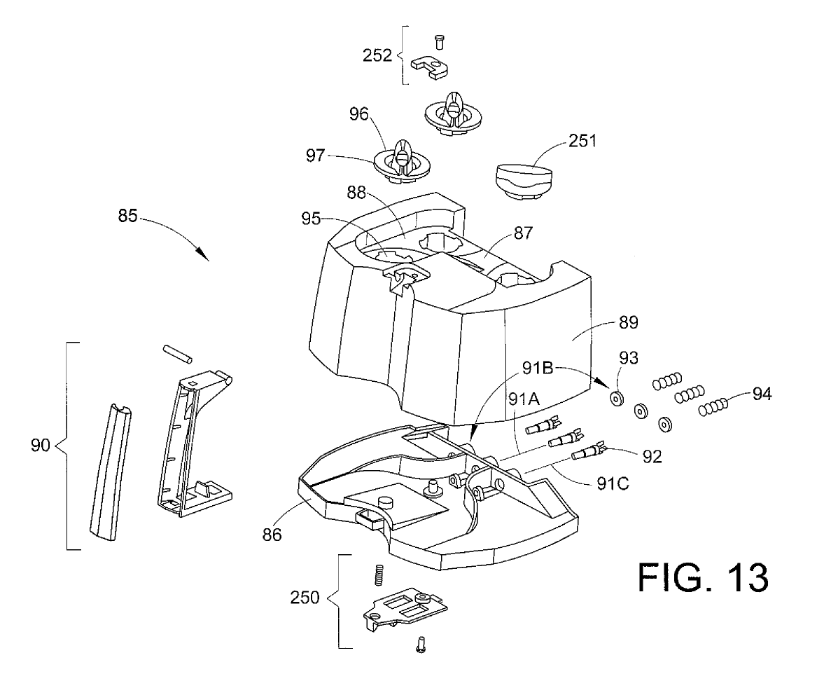

The apparatus carries a plurality of cleaning liquid supply tanks for holding a variety of cleaning liquids. With reference to FIGS. 11 and 12, a first cleaning liquid tank 80 is removably seated on lower shelf 78 and is secured to front housing half 70. Tank 80 includes a top cover 81 having a fill aperture 82 thereon. Aperture 82 is selectively closed by a cap 83 having a seal 84 secured thereto. In one embodiment, tank 80 is a water tank which, in use, is filled solely with water (e.g., warm or cold tap water), i.e., without any detergent or rinse agent. Also shown in FIG. 11 is a tank handle assembly 245 for the front side and a tank latch and spring assembly 246 for underneath water tank 80. Also shown is a tank cap valve 247 for cap 83. With reference also to FIG. 13, a chemical tank assembly 85 is secured to top shelf 77 of front housing half 70 above water tank 80 and includes a base 86 upon which second, third and fourth cleaning liquid tanks 87, 88, 89 for containing liquid chemicals are bonded or otherwise supported. In one implementation, the tanks include a detergent tank 87, a rinse agent tank 88 and a spot spray tank 89. In another embodiment, described below, rinse agent tank and/or spot spray tank are omitted. Chemical tank assembly 85 may be releasably held to front housing half 70 by a pair of latch arms (not shown) that are pivotally secured to rinse agent tank 87 and spot spray tank 89 respectively. Also for the chemical tank 85, a tank latch assembly 250 is shown along with a cap 251 and handle retainer 252.

As will become apparent, detergent tank 87 carries a liquid detergent in the form of a concentrated liquid cleaning solution and which is mixed with water from tank 80 for use during a normal cleaning operation. Rinse agent tank 88 carries a liquid rinse agent that is adapted to break down the detergent and/or to allow more complete cleaning and removal of residual soap. Finally, spot spray tank 89 carries a cleaning solution, such as a liquid detergent, used for spot spray assembly 60. The cleaning solution in tank 89 may be the same cleaning solution as is used in the detergent tank 87 or a different solution.

As shown in FIG. 14, the three tanks 87, 88, 89 are shaped to conform to each other and may be joined together as a single tank assembly 85 with three separate compartments for the three cleaning liquids. The entire assembly 85, including base 86 may be readily transported as a unit with its own carrying handle 90.

As will be appreciated, the locations of the four cleaning liquid supply tanks 80, 87, 88, 89 on the apparatus 10 are not limited to those shown. In other implementations (not shown), one or more of the tanks 80, 87, 88, 89 may be mounted on the base assembly 11 rather than on the handle assembly 12.

As shown in FIG. 13, chemical tank assembly 85 includes a separate self sealing port 91 (labeled A, B, and C, respectively) in communication with each tank 87, 88, 89 for release of the liquid from the respective tank. Each port 91 includes a valve pin 92, a seal 93, and a spring 94. Spring 94 maintains valve pin 92 in the closed position until inserted into the apparatus, whereupon the pins 92 are forced inward to open the respective port 91. In this manner, chemical tank assembly 85 may be removed from extraction cleaning apparatus 10, tanks 87, 88, and 89 filled with their respective chemicals, and reinstalled on apparatus 10 without spilling the chemical liquids. Liquids may be added to each tank via apertures 95 at the top of each respective tank. The apertures are selectively closed by lids 96 having a seal 97 secured thereto.

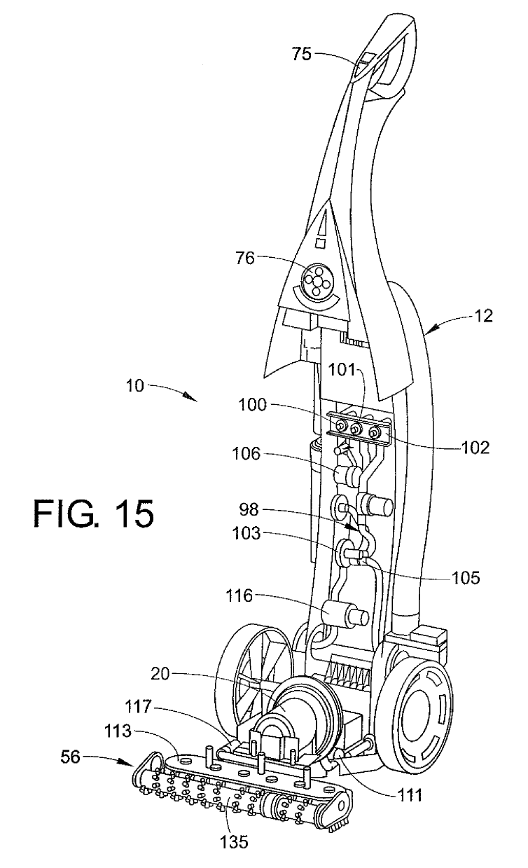

Tanks 80, 87, 88, 89 are fluidly connected with a liquid distribution system 98, which is illustrated in the cut away view of the extraction cleaning apparatus 10 in FIG. 15. When installed on extraction cleaning apparatus 10, each tank 88, 87, 89, 80 communicates with a respective chemical port 100, 101, 102, 103. Specifically, a rinse port 100 communicates with port 91B in communication with rinse tank 88. A detergent port 101 communicates with port 91B in communication with detergent tank 87. A spot spray port 102 communicates with port 91C in communication with spot spray tank 89. A water tank port 103 communicates with a port 91D located at the bottom of a rear wall of water tank 80 (FIG. 11).

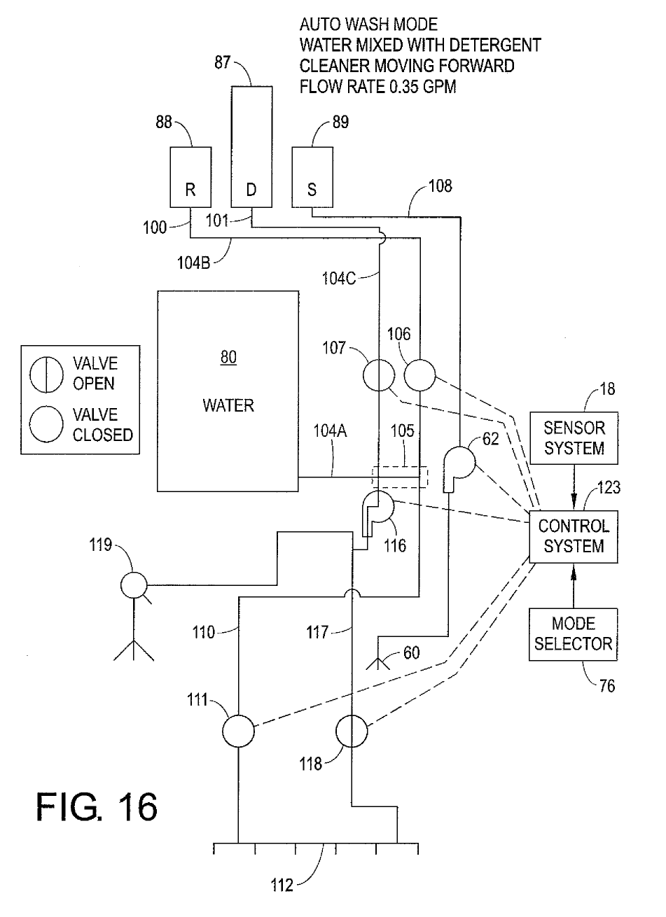

FIGS. 16-20 are schematic views of the liquid distribution system 98, which allows the extractor 10 to be operated in a variety of different cleaning modes. In particular, a first fluid line 104A fluidly connects water tank port 103 with a mixing manifold 105. Likewise, rinse port 100 and detergent port 101 are also fluidly connected to mixing manifold 105 via respective second and third fluid lines 104B, 104C. In line 104B, a rinse solenoid valve 106 is interposed between rinse port 100 and mixing manifold 105 to selectively prevent fluid communication therebetween. Similarly, in fluid line 104C, a detergent solenoid valve 107 is interposed between detergent port 101 and mixing manifold 105 to selectively prevent fluid communication therebetween. Thus, it can be seen that by selective opening and closing of valves 106, 107, water from tank 80 can be selectively mixed in mixing manifold 105 with either detergent D or rinse agent R. In the illustrated implementation, spot spray liquid S is not mixed with water at the mixing manifold 105 and, instead, bypasses the manifold and communicates directly with solenoid pump 62 in base assembly 11 via a fourth fluid line 108.

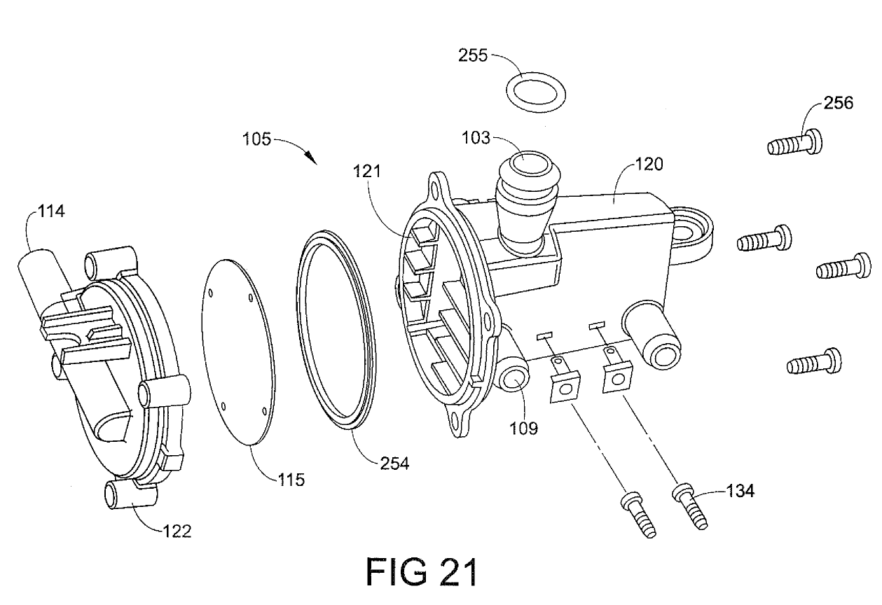

With reference also to FIG. 21, mixing manifold 105 includes two outlet ports. A first outlet port 109 is fluidly connected by fifth fluid line 110 with a second rinse solenoid valve 111 located in the base assembly (FIGS. 15 and 16). Second rinse solenoid valve 111 is in fluid communication, via fluid line 110, with a distributor 112 positioned over gear brush agitators 113 of agitator assembly 56. Cleaning liquid is dispensed by the distributor 112 onto the agitator assembly from where it is transferred to the floor and/or directly dispensed onto the floor surface. A second outlet port 114 (FIG. 21) is in communication with a filter 115 adjacent thereto. Filter 115 may be generally circular, providing a relatively large filter surface area. Thereafter, filter 115 is fluidly connected to a pump 116. As discussed in greater detail below, pump 116 may be a DC pump, such as a gear pump, and may be selectively adjustable to provide a variable flowrate of liquid therethrough. Pump 116 is fluidly connected, via a sixth fluid line 117, to a second detergent solenoid valve 118, located in the base assembly 11 (see FIG. 16). Second detergent solenoid valve 118 is in fluid communication, via fluid line 117, with distributor 112 positioned over brush agitators 113 (FIG. 15). Pump 116 is also fluidly connected to a tool trigger valve 119 (FIG. 16) that is opened when an above the floor tool is connected to extraction cleaning apparatus 10.

As shown in FIG. 21, mixing manifold 105 includes a body portion 120 defining a cavity in which baffles 121 may be arranged to encourage mixing of the incoming liquids. Filter 115 is held in position between the body portion 120 and a manifold cover 122, which carries the outlet port 114. Associated with the filter 115 is and body portion 120 around the baffles 121 is gasket 254. Also water tank port 103 can have an associated O-ring 255. Also as shown the manifold cover 122 and body portion 120 can be held together by fasteners 256.

The above-described liquid distribution system 98 allows extraction cleaning apparatus 10 to be operated in a plurality of user-selectable modes, one of which may be a default mode. The modes may be selected through operation of the manually adjustable mode control dial 76 (FIG. 10), or other suitable mode selector(s). The mode control dial 76 communicates the user's mode selection to a control system 123 (FIG. 16) which controls the components (e.g., valves 106, 107, 111, 118, and pumps 62, 116) of the liquid distribution system 98 to effectuate the user's selected mode.

The control system 123 receives signals from the sensor system 18 representative of the speed (or more specifically, the sensed rate of movement of wheel 17, relative to the floor surface) and/or direction (forward or rearward) of the apparatus 10. The terms ‘forward’ and ‘rearward’ generally refer to the directions in which the apparatus is pushed and pulled, respectively, although it is to be understood that these terms may more generally refer to first and second opposite directions.

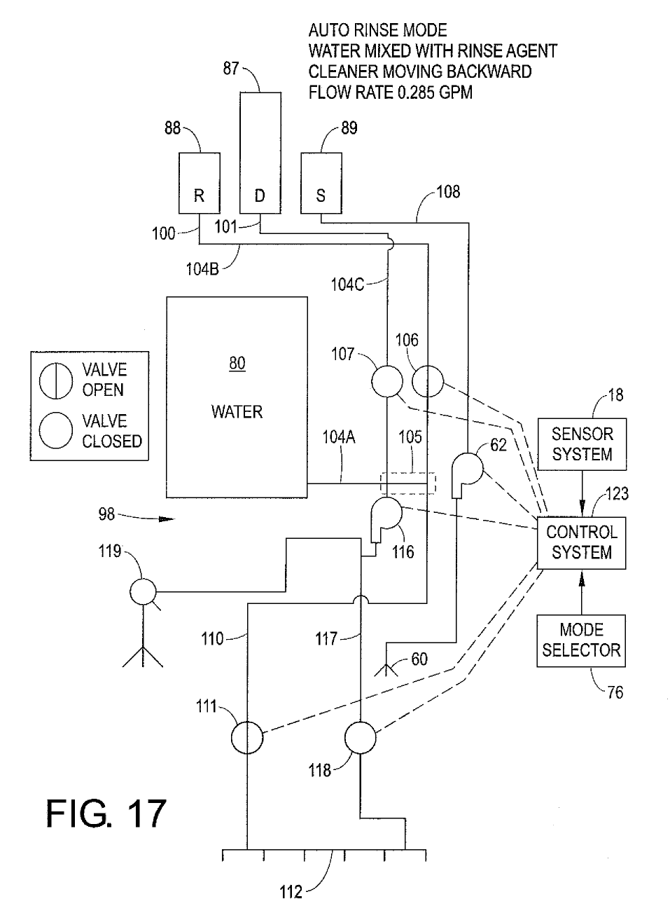

The various modes of the cleaning apparatus 10 will be described. As illustrated in FIGS. 16-17, a first mode may be an auto-wash mode which provides different cleaning solutions to the floor surface, depending on the direction of travel. For example, a mixture of water and detergent D is supplied to distributor 112 during forward motion of apparatus 10 (FIG. 16) and a mixture of water and rinse agent R during rearward travel of apparatus 10 (FIG. 17). While in the auto-wash mode, forward movement of extraction cleaning apparatus 10 (or more specifically, forward motion of the base assembly 11) triggers the application of detergent D to distributor 112 (FIG. 16). In particular, sensor 18 communicates the sensed forward motion to control system 123, which controls the components of distribution system 98 accordingly. This is accomplished by opening first and second detergent solenoid valves 107 and 118 and closing first and second rinse solenoid valves 106 and 111. Simultaneously, pump 116 draws detergent D from detergent tank 87 and water from water tank 80 into mixing manifold 105. The mixture is then drawn through pump 116 and through second detergent solenoid valve 118 and thereafter to distributor 112. The opening and closing of the valves (and optionally also the actuation of pump 116) is initiated by the control system 123. At distributor 112, the detergent mix is distributed over agitators 113 and applied to the carpet or other floor surface to break up and remove dirt and stains.

Referring now to FIG. 17, while in the auto-wash mode, rearward movement of extraction cleaning apparatus 10 (or more specifically, base assembly 11) triggers the application of rinse agent to distributor 112. This is accomplished by opening first and second rinse solenoid valves 106 and 111 and closing first and second detergent solenoid valves 107 and 118. While in this configuration, gravity draws rinse agent R from rinse tank 88 and water from water tank 80 into mixing manifold 105. Under the force of gravity, the mixture exits mixing manifold 105, is directed through second rinse solenoid valve 111 and thereafter to distributor 112. At distributor 112, the rinse agent is distributed over agitators 113 and applied to the carpet to break down the detergent to allow better rinsing and removal of the detergent.

It should further be appreciated that, during application of any of the liquids, the measured speed of the apparatus 10 may be monitored by the control system 123 and the application of fluids adjusted depending upon speed. Specifically, if a user pushes the apparatus 10 faster, this increase in speed is detected by sensor system 18, communicated to control system 123, and the flow rate through pump 116 may be increased. Correspondingly, if a user pushes the apparatus slower, the flow rate may be reduced. In this manner, a uniform optimal distribution of liquids may be achieved.

Additionally, the flow rate of liquid through the pump 116 may be adjusted depending on the direction. For example, in the forward (cleaning) direction the flow rate may be controlled by control system 123 so that it is higher than in the rearward (rinse) direction at the same speed, i.e. more liquid is applied to the floor in the forward direction than in the rearward direction. In one embodiment, the flow rate of the pump 116 may be the equivalent of about 0.35 grams/minute detergent for the forward direction and 0.285 grams/minute rinse agent in the rearward direction.

As will now be appreciated, in the autowash-mode, a rate at which the detergent (e.g., as measured in g/min) is supplied to the distributor may be based on at least one of the sensed direction of travel and a (forward/rearward) speed of the cleaning apparatus and is generally zero in the rearward direction. Analogously, a rate at which the rinse agent (e.g., as measured in g/min) is supplied to the distributor may also be based on at least one of the sensed direction of travel and a (forward/rearward) speed of the cleaning apparatus, and is generally zero in the forward direction. Although in the exemplary embodiment, the flow rate is varied by adjusting the flow rate of pump 116, it is also contemplated that partial opening /closing of appropriate valves 106, 107, 111, 118 may be used to adjust the flow rate of chemicals to the distributor.

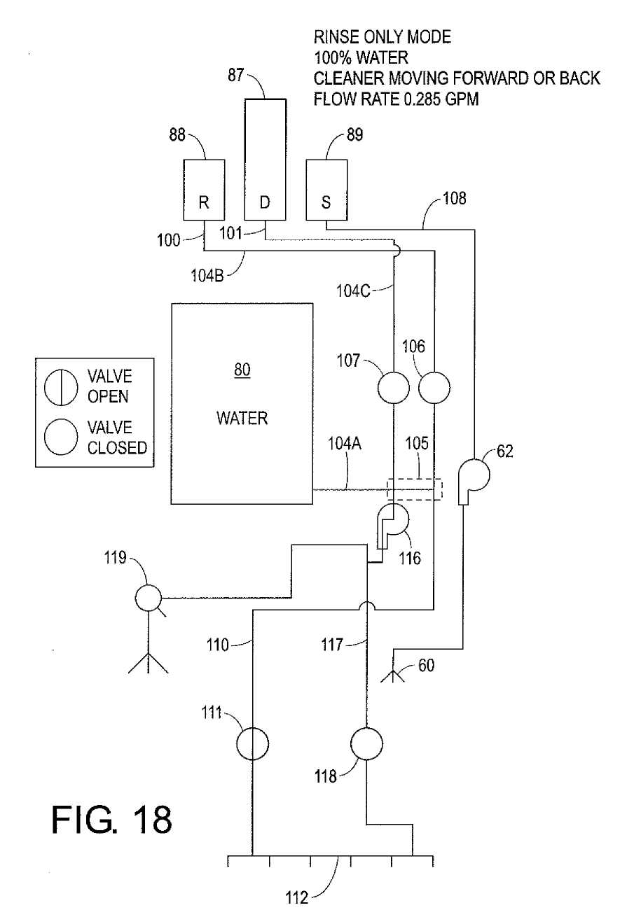

Referring now to FIG. 18, a user may wish to use extraction cleaning apparatus 10 to clean surfaces without application of any detergents or rinse agents. In such instances, the user may place the apparatus 10 in a water only mode, through manipulation of mode control dial 76. The model selection is communicated to the control system 123, which controls the fluid distribution system 98 accordingly. In such a mode, water is applied during both forward and rearward movement of apparatus 10. This is accomplished by closing first solenoid rinse valve 106 and closing first and second detergent solenoid valves 107 and 118. Second solenoid rinse valve 111 is simultaneously opened allowing water, under the force of gravity, to travel from water tank 80 into mixing manifold 105. Water then exits mixing manifold 105, is directed through second rinse solenoid valve 111 and thereafter to distributor 112 via line 110. At distributor 112, the water is distributed over agitators 113 and applied to the carpet. In another implementation, a rinse aid mode may be provided in which rinse aid such as any available under the Hoover brand name distributed by Royal Appliance Mfg. Co. of Glenwillow Ohio is added to the water in forward and rearward motion, using the valve arrangement shown in FIG. 17.

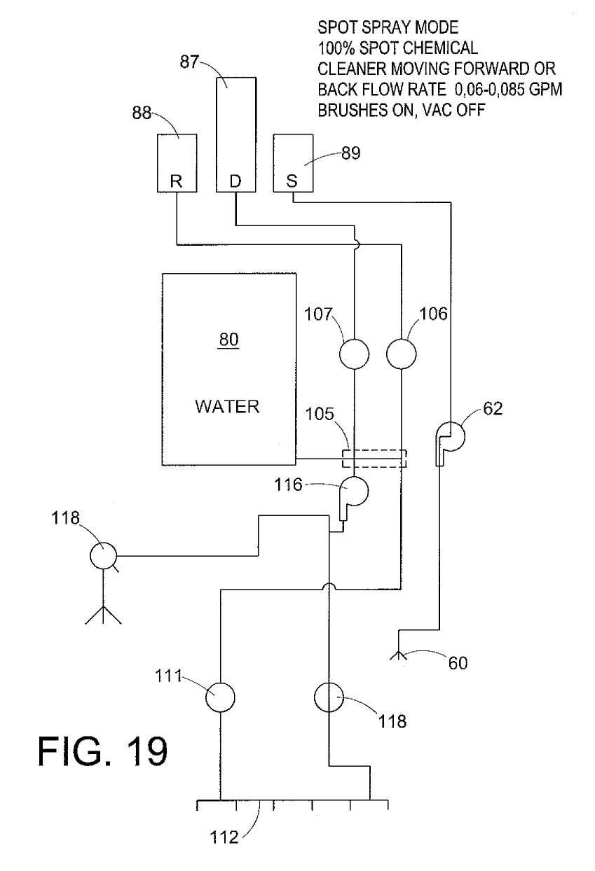

Referring now to FIG. 19, when a user desires to use the spot sprayer 60, the user may manually select spot spray on the selector 76, which is communicated to control system 123. Pump 62 is then actuated, drawing spot spray liquid through pump 62 and into spot spray assembly, where it is directed through first or second orifice 64 or 65. In the spot cleaning mode, the control system may deactivate the motor assembly 20 so that cleaning liquid is not recovered from the floor. The spot cleaner may be applied during forward and backward motion at a constant flow rate of about 0.06-0.085 g/min. In one embodiment, the spot cleaner is only applied when the trigger 66 is squeezed by the operator. In another implementation, spot cleaning may also be performed while in the auto-wash mode, by squeezing the trigger 66 (FIG. 10).

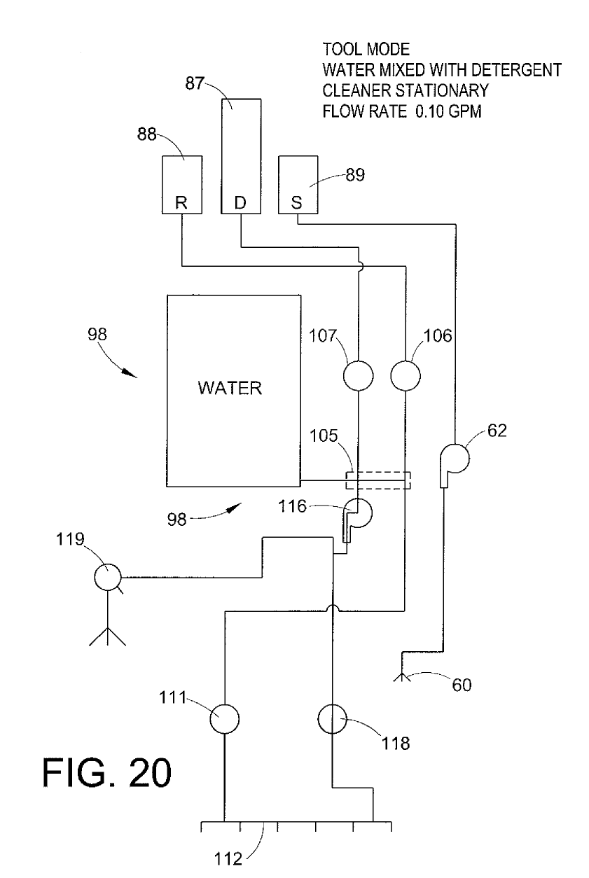

Referring now to FIG. 20, a user may desire to use an above the floor tool 119 to clean stairs, furniture or the like. This is accomplished by closing first and second rinse solenoid valves 106 and 111 as well as second detergent solenoid valve 118, while opening first detergent solenoid valve 107. While in this configuration, upon opening of tool trigger valve 118, pump 116 draws detergent from detergent tank 87 and water from water tank 80 into mixing manifold 105. The mixture is then drawn through pump 116 and through tool trigger valve 118 and thereafter to above the floor tool 119. The user may use the selector 76 to select the above floor mode. In another embodiment, the above floor cleaning mode is automatically triggered when the above floor tool is connected, thereby actuating flap valve 35 (FIG. 6).

Regarding the chemicals used in the cleaning apparatus 10, these may be tailored to the surface to be cleaned, such as hard floor or carpet. The water tank 80 may be filled with warm or cold tap water, which may be heated to a higher temperature, generally below boiling, by a heater (not shown) positioned in or around the tank or in the fluid line 104A and/or 110, 117. It is also contemplated that other additives may be added to the water tank for some applications. As used herein the word ‘detergent’ broadly encompasses cleaning liquids containing surfactants, natural and synthetic soaps, enzymatic cleaning agents, combinations thereof and the like, which aid in removal of dirt from the floor surface. The rinse agent R may have a suitable pH for breaking down the residual detergent D on the carpet and/or contain release agents which aid in removal of residual detergent from the carpet. In general, the rinse agent R is detergent-free. Exemplary rinse agents suitable for carpets are available from Royal Appliance Mfg. Co. of Glenwillow, Ohio under the Hoover brand label and from Prochem, a division of Kärcher Floor Care, 1351 W. Stanford Av., Englewood, Colo. 80110.

It should be appreciated that other modes and configurations are envisioned and encompassed herein. For example, apparatus 10 may be placed in a surge mode, wherein the valves are placed in the same configuration as discussed above when in auto-wash mode with the apparatus moving forward. However, while in surge mode, pump 116 may be operated at a higher speed, thereby pumping a greater amount of detergent mixture to distributor 112.

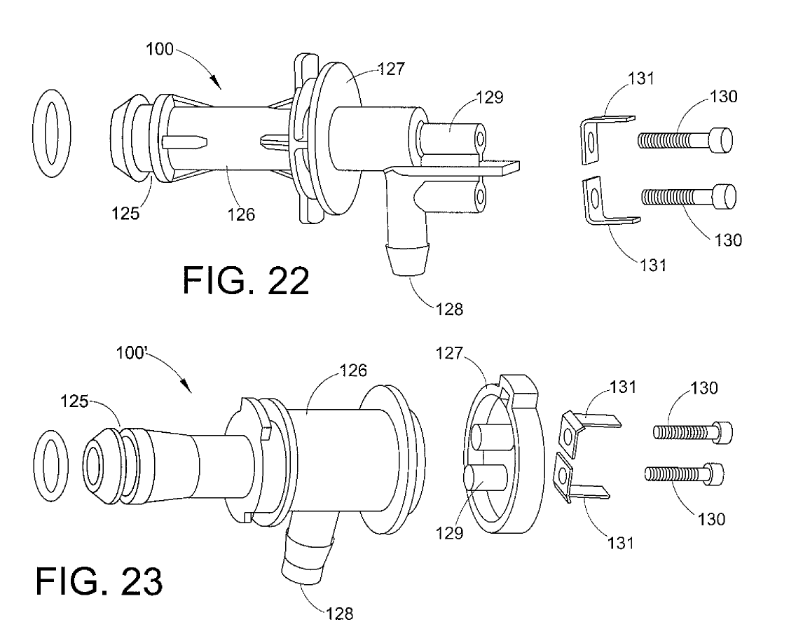

With reference now to FIGS. 22 and 23 a fluid monitoring system may be employed to ensure that the chemical and water tanks are filled. Rinse, spot spray, and detergent ports 100, 101, and 102 are each of generally identical design and are shown enlarged in FIGS. 22 and 23, where FIG. 23 shows a slightly modified version of the port identified by the numeral 100′. Each port includes a nipple 125 adapted to engage self sealing port 91. Nipple 125 terminates at a cylindrical housing 126 that is enclosed by a cap 127. An outlet 128 extends from the cap 127 (or housing 126, FIG. 23) and is adapted to couple to tubing forming fluid lines 104B, 104C, 108 (FIG. 16) that connects to the downstream fluid transfer components. In this manner, fluids enter housing 126 via nipple 125 and exit via outlet 128. Cap 127 includes a pair of cylindrical bosses 129 that extend into the chamber formed by housing 126. Bosses 129 are hollow and are each adapted to receive screws 130 therein. Each screw 130 extends beyond boss 129 and into a chamber formed by housing 126/cap 127. Finally, an electrical lead 131 is positioned in electrical contact with each screw 130. As is known in the art, liquids conduct electricity more efficiently than air. Thus, it is possible to monitor the conductance between screws 130. When the respective tank is empty, the conductance between screws 130 decreases and an indicator 132 in the handle 12 can alert the user that the tank needs refilled.

Referring once again to FIG. 21, mixing manifold 105 may also include a fluid monitoring element. As above, a pair of screws 134 may extend into the internal chamber of manifold 105 so that they are immersed in the fluid within. As is evident, the water tank port 103 terminates at mixing manifold 105, and therefore, by monitoring the conductance between screws 134, it can be determined whether water tank 80 is empty. Specifically, if the conductance between screws 134 decreases, an indicator in the handle 12 can alert the user that the water tank needs refilled.

With reference once more to FIGS. 5 and 15, the agitator assembly may include a cylindrical agitator brush roll 135. Cylindrical brush roll 135 is used in conjunction with gear brushes 113 to thoroughly agitate the surface while also leaving desirable “sweeper tracks”. Cylindrical brush roll 135 further includes a plurality of brush bundles 136 in a split serpentine pattern. In one embodiment, the split serpentine pattern directs dirt and debris axially inward during rotation. This may be desirous if the greatest amount of suction is proximate the axial center of the brush. In other embodiments, brush roll 135 may be rotated in the opposite direction, thereby causing dirt and debris to be directed axially away from the center of brush roll 135. This may be desirable if the greatest suction is proximate to the axial ends of the brush roll 135.

The apparatus 10 may further include an active edge cleaning feature. In particular, a reciprocating brush 142 is carried by brush roll 135 in a manner that allows forward arid rearward sliding motion. The brush 142 may be driven by a belt 143 which drives the brush roll 135 or by a spur gear linked to a drive gear for the agitator brushes 113 (not shown) to cause brush 142 to reciprocate back and forth. In this manner, active edge cleaning is achieved.

As will be appreciated, the agitator assembly 56 of cleaning apparatus 10 may alternatively include a single cylindrical rotating brush roll, analogous to brush roll 135, or dual cylindrical rotating brush rolls which rotate(s) about horizontal axis, without the need for any gear agitators 113. In other embodiments, the agitator assembly 56 may comprise a set of gear agitators which rotate about a vertical axis, analogous to gear agitators 113, without the need for a brush roll.

With reference once more to FIG. 6, as noted previously, the lid 32 of recovery tank 30 includes an input port 48 that receives working air from nozzle 45. Air is drawn along a channel 145 and then into tank 31 via an orifice 146. Thereafter, water separates from the working air, which is then drawn into inlet port 24 of vacuum motor 20 (FIG. 5). As can be seen, working air communicates with inlet port 24 via a generally crescent shaped path 147 having an opening from the tank 31 and a second opening 148 located at a rearward end of path 147. It is advantageous that the openings be as large as possible so that the velocity of air drawn through them is as low as possible. Low air velocity prevents unwanted foaming in tank 31 and also prevents liquid from being drawn into vacuum motor 22 along with the working air. In other words, if working air is drawn very quickly (i.e., with high velocity) out of tank 31, it tends to carry with it liquids from tank 31. By providing a large tank opening, the velocity of air is reduced as it exits tank 31 and travels to inlet port 24. In one or more embodiments, the velocity of air exiting tank 31 through opening 148 is less than five miles per hour. In other embodiments, the velocity is less than three miles per hour. In these or other embodiments, the opening into passage 147 and opening 148 each has an area that is greater than three times the area of input port 24. In still other embodiments, the opening into passage 147 and opening 148 each has an area greater than 5 times, or greater than 7 times, the area of input port 24. In this manner, greater liquid separation and correspondingly, greater vacuum life can be achieved.

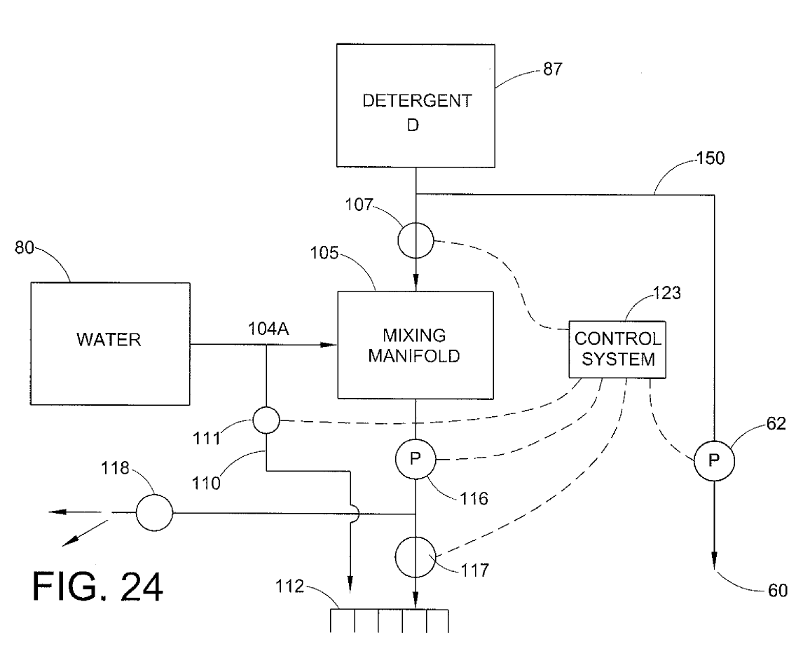

FIG. 24 shows an alternative liquid distribution system which may be used in an extraction cleaning apparatus substantially as shown in FIGS. 1-4. This embodiment may be similarly configured to that shown in FIGS. 16-20, except as otherwise noted. Similar elements are accorded the same numbers and new elements are accorded new numbers. In this embodiment, the rinse agent tank and spot cleaning tank are omitted. For the auto-wash mode, detergent is mixed with water for the forward direction and as for the embodiment of FIG. 16. For the reverse direction, valves 107 and 117 are closed and water is allowed to flow under gravity to the distributor via line 110, by opening valve 111. In this embodiment, there is no rinse agent added for the reverse travel. The apparatus relies on water to rinse most of the detergent out of the carpet. As for the other embodiments, the opening and closing of the valves 107, 110, 117, and operation of the pumps 62, 116, is under the control of the control system 123, in response to a user selection via the selector 76, and sensed direction and speed information from the sensor system 18.

For the water wash mode, clean water is supplied to the distributor 112, as described for the embodiment of FIG. 18. For the spot clean mode, the detergent in the detergent tank 87 is used as the spot cleaning agent. A fluid line 150 connects the tank 87 with the pump 62 and spot sprayer 60.

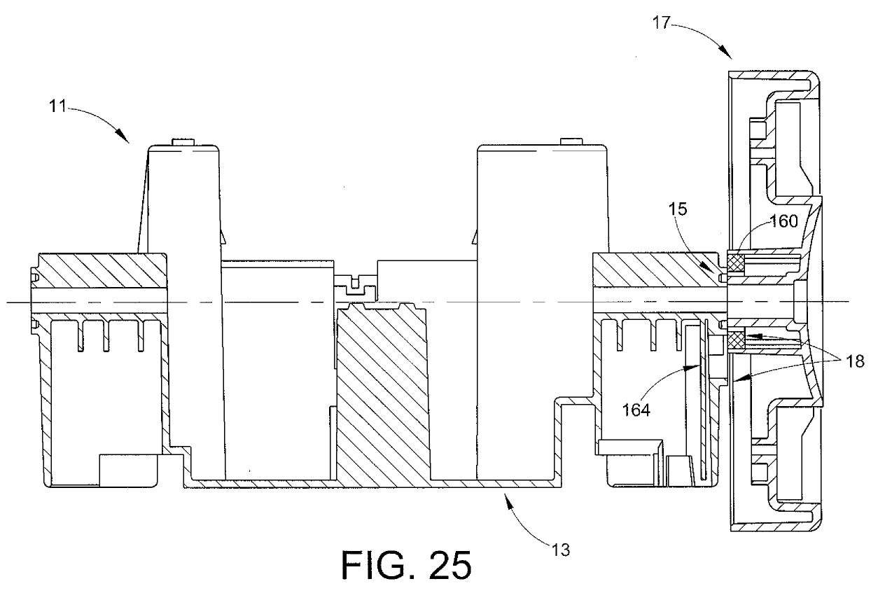

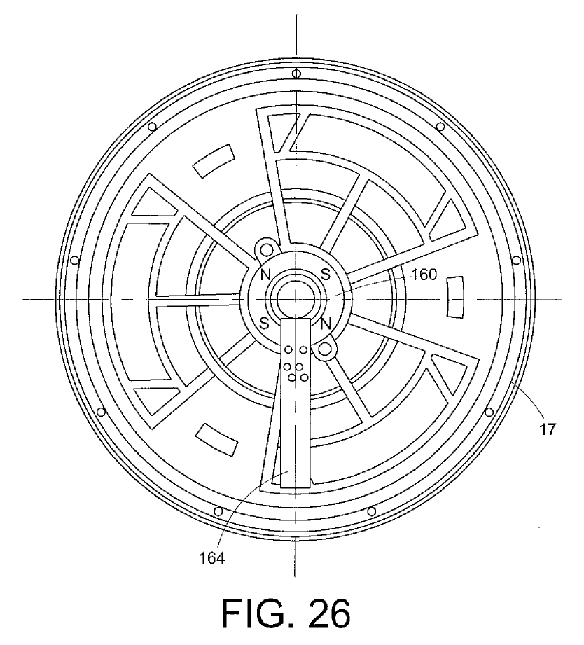

In all the embodiments disclosed herein, the relative motion and speed (rate of movement) of apparatus 10 may be monitored by the sensor system 18 positioned proximate rear wheels 17. The sensor system 18 may include one or more sensors that determine the rotational speed of the wheels (or other measure of the rate of movement of the apparatus 11) and/or direction of travel thereof. In one embodiment, the sensor system 18 includes an arrangement of one or more magnets 160 (FIG. 25), arranged in an annulus around the interior of the wheel 17 as shown in FIG. 26. The magnets 160 rotate as the wheel rotates. The magnets create a changing magnetic field which is sensed by a sensor, such as a Hall effect sensor 164. The Hall effect sensor 164 includes a transducer that varies its output voltage in response to changes in the magnetic field, from which the speed and direction of the base assembly can be deduced. In the exemplary embodiment each revolution of the wheel generates two voltage changes. The interval between voltage changes can thus be used as an indication of the speed of the apparatus. As an alternative to a Hall effect sensor, a mechanical switch (not shown) detects whether the wheel 17 is moving in a forward or rearward direction. In other embodiments, speed and direction may be determined by sensors (not shown) in the handle assembly 12 that sense whether the user is pushing or pulling on extraction cleaning apparatus 10. In still other embodiments, sensors may be positioned at the bottom of main body 13 to directly sense speed and direction based on visual or mechanical detection of the surface being cleaned.

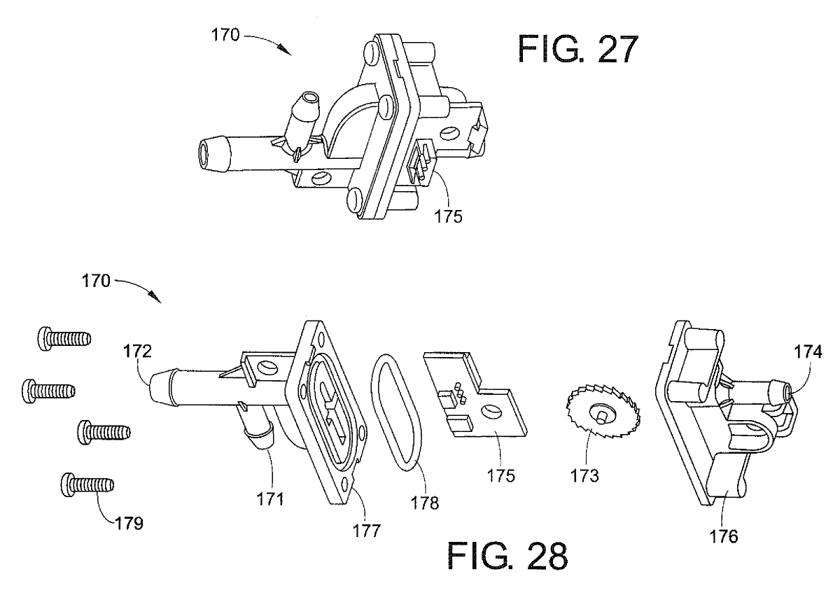

With reference now to FIGS. 27 and 28, a low flow meter 170 suitable for use in the hose for the above-floor tool is shown. Water from the pump 116 enters the flow meter 170 in port 171 as shown in FIG. 27. If cleaning floors, the water makes an approximate 90 degree turn and exits port 172. If the extractor is in above-floor cleaning mode, and the user pulls the trigger 66 to dispense solution, the water moves across the geared center magnet 173, causing it to rotate, as the water flows out port 174 to an attached hose, not shown in FIGS. 27 and 28. The gear tooth center magnet 173 sends impulses to the hall sensor board 175 to interact with the sensor system, 18, where 175 is mounted on the exterior of the flow meter 170. Sensor board 175 sends the signal to the Control Board 123 of sensor system 18, which detects hose flow and opens the chemical solenoid valve 107 to allow detergent to mix with the water. When the user ceases to pull the trigger 66 on the hose, flow past the flow meter magnet 173 ceases, the hall sensor 175 sees no impulses, and the control system 18 closes the detergent solenoid valve 107. As shown in FIG. 28, the low flow meter 170 with the two housing halves 176 and 177 usually held together by fasteners 179 is in exploded view showing an O-ring seal 178.

While aspects of the exemplary embodiment disclosed herein refer to an upright extractor, it is to be appreciated that the extractor may alternatively be of the canister type in which the base assembly is mounted to a distal end of a cleaning wand. The recovery tank and cleaning liquid tanks may all be located in a wheeled canister housing and fluidly connected with the base assembly by the wand.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An extraction cleaning apparatus comprising:
a first cleaning liquid supply tank configured to hold a first cleaning liquid;
a second cleaning liquid supply tank configured to hold a second cleaning liquid;
a base assembly which dispenses the first and second cleaning liquids on to a floor surface and receives recovered cleaning liquid from the floor surface;
a liquid distribution system in communication with the first cleaning liquid supply tank and the second cleaning liquid supply tank, which selectively conveys the first and second cleaning liquids to the base assembly;
a sensor system which senses at least one of a direction of travel and a rate of movement of the cleaning apparatus;
the apparatus having at least a first cleaning mode in which a rate at which the first cleaning liquid is dispensed from the base assembly is based on at least one of the sensed direction of travel of the cleaning apparatus and a rate of movement of the cleaning apparatus.

2. The extraction cleaning apparatus of claim 1, wherein the first cleaning liquid tank is configured for holding a detergent.

3. The extraction cleaning apparatus of claim 1, wherein the second cleaning liquid tank is configured for holding at least one of water and a rinse agent.

4. The extraction cleaning apparatus of claim 1, further comprising a third cleaning liquid tank and wherein the second cleaning liquid tank is configured for holding water and the third cleaning liquid tank is configured for holding a rinse agent.

5. The extraction cleaning apparatus of claim 4, wherein when the sensed direction is a first direction, the liquid delivery system is configured to convey a mixture comprising detergent from the first tank and water from the second tank to the base assembly for applying to the floor surface, and when the sensed direction is a second direction, the liquid delivery system is configured to convey rinse agent from the third tank and optionally water from the second tank to the base assembly for applying to the floor surface.

6. The extraction cleaning apparatus of claim 4, wherein the liquid delivery system includes a mixing manifold fluidly connected with the first, second and third cleaning fluid tanks.

7. The extraction cleaning apparatus of claim 6, wherein the liquid delivery system further includes an arrangement of valves for selectively fluidly disconnecting at least one of the cleaning liquid tanks from the mixing manifold.

8. The extraction cleaning apparatus of claim 1, wherein when the sensed direction is a first direction, the liquid delivery system is configured for delivering a mixture of water and a detergent to the base assembly for applying to the floor surface, and when the sensed direction is a second direction, the liquid delivery system is configured for delivering at least one of water and a rinse agent to the base assembly for applying to the floor surface.

9. The extraction cleaning apparatus of claim 8, wherein when the sensed direction is the second direction, the liquid delivery system is configured for delivering the rinse agent to the base assembly for applying to the floor surface.

10. The extraction cleaning apparatus of claim 8, wherein when the sensed direction is a second direction, liquid flow from the first cleaning liquid tank is interrupted.

11. The cleaning apparatus of claim 1, wherein the liquid delivery system further comprises a pump for selectively delivering at least one of a detergent from the first cleaning liquid tank and water from the second cleaning liquid tank to the base assembly.

12. The cleaning apparatus of claim 11, wherein the pump is a variable flow pump which varies a rate of delivery of the detergent to the base assembly in response to a sensed variation in the rate of movement.

13. The cleaning apparatus of claim 11, wherein the variable flow pump is positioned in the liquid delivery system to receive a mixture of cleaning liquids comprising detergent from the first cleaning liquid tank and water from the second cleaning liquid tank and varies a rate of delivery of the mixture of cleaning liquids to the base assembly in response to a sensed variation in the rate of movement.

14. The cleaning apparatus of claim 11, wherein when the sensed direction is the second direction, the pump is switched off and a rinse agent is delivered to the base assembly by the liquid delivery system under gravity.

15. The cleaning apparatus of claim 1, further comprising a spot cleaning liquid tank and a spot spray nozzle, the liquid delivery system configured for selectively conveying a spot cleaning liquid from the spot cleaning liquid tank to the spot spray nozzle.

16. The cleaning apparatus of claim 15, wherein the base assembly comprises a suction nozzle for recovery of cleaning liquid which selectively communicates with a source of suction and wherein the cleaning apparatus further includes a spot spray mode and wherein when the spot spray mode is selected, the communication between the suction nozzle and source of suction is at least partially interrupted.

17. The cleaning apparatus of claim 1, further comprising:
a mode selector which enables a user to select a cleaning mode from a plurality of cleaning modes including the first cleaning mode and a least a second cleaning mode; and
a control system in communication with the mode selector which controls the liquid delivery system to effectuate the selected cleaning mode.

18. The cleaning apparatus of claim 17, wherein the at least a second modes is a water only mode in which the control system controls the liquid delivery system to deliver detergent-free water to the floor surface.

19. The cleaning apparatus of claim 17, wherein the liquid delivery system includes valves which selectively interrupt flow from respective cleaning liquid tanks to the distributor and wherein the control system selectively actuates the valves.

20. The cleaning apparatus of claim 1, further comprising a control system which controls the liquid delivery system whereby the rate of detergent delivery to the base assembly is higher in a first direction than in a second direction and in the first direction is varied based on the detected rate of movement.

21. A method of cleaning a floor with the apparatus of claim 1, comprising:
when the apparatus is in the first mode,
automatically dispensing the first cleaning liquid from the base assembly at a first rate when the sensed direction of travel is a first direction, and
automatically dispensing the first cleaning liquid from the base assembly at a second rate, lower than the first rate, when the sensed direction of travel is a second direction.

22. The method of claim 21, wherein the second rate is zero.

23. The method of claim 21, further comprising, varying the first rate automatically, based on the sensed rate of movement of the apparatus.

24. The method of claim 23, wherein the varying of the first rate includes adjusting a variable rate pump of a delivery system which delivers the first cleaning liquid and optionally the second cleaning liquid to the floor.

25. A cleaning apparatus comprising:
a first cleaning liquid supply tank configured to hold a supply of a first cleaning liquid;
a second cleaning liquid supply tank configured to hold a supply of a second cleaning liquid;
a liquid distribution system in communication with the first and second cleaning liquid supply tanks, which selectively conveys the first and second cleaning liquids to a distributor;
a sensor system which senses at a direction of travel of the cleaning apparatus; and
a control system in communication with the sensor system which controls the liquid delivery system such that the first cleaning liquid is applied to the floor surface from the distributor when the sensed direction of travel is a first direction and the second cleaning liquid is applied to the floor surface from the distributor when the sensed direction of travel is the second direction, whereby a composition of the cleaning liquid applied to the floor surface from the distributor is different in the first and second directions.

26. The cleaning apparatus of claim 25, wherein the first cleaning liquid comprises a detergent and the second cleaning liquid comprises a rinse agent.

27. A method of cleaning a floor with the cleaning apparatus of claim 25, comprising:
detecting a direction of travel with the sensor system and when the direction is the first direction, controlling the liquid delivery system to deliver the first cleaning liquid to the distributor and when the direction is the second direction, controlling the liquid delivery system to deliver the second cleaning liquid to the distributor, the first cleaning liquid comprising a detergent and the second cleaning liquid comprising a rinse agent for aiding removal of the detergent from the floor surface.

28. A liquid delivery system for a floor cleaning apparatus comprising:
a first tank for holding a supply of water;
a second tank for holding a supply of detergent;
a third tank for holding a supply of rinse agent;
an arrangement of fluid lines and valves which selectively connect the first second and third tanks with a liquid distributor;
a control system in operative communication with the valves whereby a composition of cleaning liquid comprising the at least one of the water, detergent, and rinse agent delivered to the distributor is varied, based on a detected direction of travel of the floor cleaning apparatus.

29. The liquid delivery system of claim 28, further comprising:
a mixing manifold fluidly connected with the first tank, second tank and third tank for mixing water with one of detergent and rinse agent to form the cleaning liquid.
